(19) United States
(12) Patent Application Publication
(10) Pub. No.: US 2018/0062287 A1
(43) Pub. Date: Mar. 1, 2018

(54) SYSTEM AND METHOD FOR RETAINING MEMORY MODULES

(71) Applicant: Crystal Group Inc., Hiawatha, IA (US)

(72) Inventors: James E. SHAW, Ely, IA (US); Rachel MANSON, Delmar, IA (US); Chase MARSDEN, Cedar Rapids, IA (US); Robert GRAHAM, Cedar Rapids, IA (US); Brent SIEVERS, Cedar Rapids, IA (US); Shawn CASTILLO, Marion, IA (US)

(21) Appl. No.: 15/692,289

(22) Filed: Aug. 31, 2017

Related U.S. Application Data
(60) Provisional application No. 62/381,939, filed on Aug. 31, 2016.

(51) Int. Cl. H01R 12/70; H01R 12/73

(52) U.S. Cl. CPC H01R 12/7029; H01R 12/737

(57) ABSTRACT

The present invention is an apparatus and method for allowing for the use of commercial dual inline memory module (DIMM) in high shock and vibration environments while preserving serviceability. This system extends the performance of the standard Joint Electron Device Engineering (JEDEC) memory connectors in said environments without sacrificing high speed electrical performance. The system provides a simple clip which locks the module in place using the standard connector latches preventing relative motion of the connector and the DIMM thereby insuring uninterrupted computational performance.

### CROSS REFERENCE TO RELATED APPLICATIONS

This application claims the benefit of the filing date of the provisional patent application having Ser. No. 62/381,939 filed Aug. 31, 2016, the contents of which is incorporated herein in its entirety by this reference.

### FIELD OF THE INVENTION

The present invention generally relates to computers and electronic equipment, and more particularly relates to industrial and military computers, and even more particularly relates to methods and systems for providing rugged DIMM connections for use in demanding and hostile environments

### BACKGROUND OF THE INVENTION

Server class compute platforms are typically not employed in environments that are harsh, such as military vehicles, construction vehicles, weapons platforms, space launch systems, and etc. These server platforms are becoming necessary because of the need for virtualization and compute density in smaller spaces. One of several obstacles requiring resolution is the fragility of the Joint Electron Device Engineering Council (JEDEC) style DIMM connector on these compute platforms. This connector is a high speed (electrical speeds in the 2-3 GHz range) interface using a leaf spring style contact which creates a line of surface electrical conduction where the spring side of the connector touches the circuit side of the DIMM via a gold plated pad on the circuit card. See FIG. 1.

When acceleration is imparted on the masses of the compute platform, the forces can exceed the contacts ability to maintain surface contact with the circuit card housing the memory chips. More frequently, the spring contact and the circuit card lose electrical connectivity when the chassis is distorted. This level of chassis deflection creates enough force to curve the motherboard, which drives the JEDEC latch up and the DIMM out of the connector, thereby creating a break in the electrical connectivity between the DIMM and the motherboard. The latch, which is designed to both retain the memory as well as extract the memory, is prone to creating a problem in shock and vibration. This is a particularly devastating event for these system architectures as they fail to operate normally thereafter until the connection is reestablished. Previous solutions have involved permanently bonding the DIMM into the connector of applying a retention band, which must be damaged on removal. The former is unserviceable while the latter requires depot repair.

Consequently, there exists a need for improved methods and systems for connecting JEDEC memory modules in a compute platform used in harsh environments, such as military vehicles, weapons platforms, and space launch systems, all done in a reliable and cost efficient manner.

### SUMMARY OF THE INVENTION

It is an object of the present invention to provide a system and method for connecting memory modules via a DIMM connector in an efficient manner.

It is a feature of the present invention to utilize a retention clip.

It is an advantage of the present invention to reduce inadvertent disconnection of memory modules from a DIMM connector.

It is another feature of the present invention to include a bumper spacer between adjacent retention clips.

It is another advantage of the present invention to provide a self-alignment capability for a plurality of adjacent retention clips.

It is yet another feature of the present invention to have a tab on the ends of clip.

It is still another advantage of the present invention to further deter rotation of a connector latch.

It is still another feature to have a lid contacting surface on the retention clip.

It is still another advantage of the present invention to provide a lid induced clamping force on a connector latch.

It is yet another feature to include a memory module mounted retention clip.

It is still an advantage to reduce a possibility of loose pieces occurring inside the system.

The present invention is an apparatus and method for making more robust the connections between a memory module and a JEDEC style DIMM connector to satisfy the aforementioned needs, provide the previously stated objects, include the above-listed features, and achieve the already articulated advantages. The present invention is carried out in a “inadvertent latch rotation-less” manner in a sense that the likelihood, of an unwanted disconnection of a memory module has been greatly reduced.

Accordingly, the present invention is a system comprising:
A system for reducing inadvertent disconnection of memory modules during operation in harsh environments comprising:
   a plurality of disconnection protected systems arranged in a parallel array; wherein each of said plurality of disconnection protected systems comprises:
      a DIMM connector 120;
      a DIMM memory module 110, having a memory module top edge 108;
      a retention clip 200 having:
         a retention clip central portion 208, having a retention clip first end 202 and retention clip second end 204;
         a retention clip first angled portion 212 and retention clip second angled portion 214 disposed on opposing ends of said retention clip central portion 208;
         a retention clip first latch engaging end 222 and a retention clip second latch engaging end 224 disposed on said retention clip first angled portion 212 and retention clip second angled portion 214, respectively;
         said retention clip central portion 208 having a retention clip central portion top side 209 and a retention clip central portion bottom side 207, which has a retention clip bottom side top edge receiving groove 203 disposed therein, which is configured to receive therein said memory module top edge 108;
         a plurality of retention clip first face bumper spacers 206;
         a plurality of retention clip second face bumper spacers 205;
         a retention clip first latch engaging tab 232 disposed on an interior side of said retention clip first latch engaging end 222;
         a retention clip second latch engaging tab 234 disposed on an interior side said retention clip second latch engaging end 224 facing said retention clip first latch engaging tab 232; and
         wherein said array is spatially configured such that each retention clip 200 in said plurality of disconnection protected systems has at least one of said plurality of retention clip first face bumper spacers 206 and said plurality of retention clip second face bumper spacers 205 thereon in contact with one of said plurality of retention clip first face bumper spacers 206 and said plurality of retention clip second face bumper spacers 205 of another retention clip 200 of said plurality of disconnection protection systems.

Accordingly, the present invention is a method comprising the steps of:
A method of reducing inadvertent disconnection of memory modules during operation in harsh environments comprising the steps of:
   providing a retention clip configured with a retention clip first latch engaging end 222 and a retention clip second latch engaging end 224:
      installing a DIMM memory module 110 into a DIMM connector 120 having a first pivoting latch 122 and a second pivoting latch 124; and
      engaging said retention clip with all of said DIMM memory module 110; and engaging said retention clip first latch engaging end 222 and said retention clip second latch engaging end 224 with said first pivoting latch 122 and said second pivoting latch 124, respectively.

### BRIEF DESCRIPTION OF THE DRAWINGS

The invention may be more fully understood by reading the following description of the preferred embodiments of the invention, in conjunction with the appended drawings wherein:

FIG. 1 is an exploded perspective view of a prior art latchable DIMM connector system.

FIG. 2 is a perspective view of a retention clip of the present invention.

FIG. 3 is a perspective view of a portion of a retention clip system of the present invention which include the retention clip of FIG. 2 together with the latchable DIMM connector and memory module of FIG. 1 in an assembled configuration.

FIG. 4 is a perspective view of a portion of the retention clip of the present invention.

FIG. 5 is an upside down cross-sectional view of the retention clip from FIG. 4.

FIG. 6 is a cross-sectional view of the present invention, with a lid contacting the retention clip from FIG. 4.

FIG. 7 is a cross-sectional view of an alternate embodiment of a retention clip of the present invention.

FIG. 8 is a perspective view of the retention clip of the present invention from a different angle than FIGS. 2 and 4.

FIG. 9 is a bottom view of a pair of adjacent retention clips of the present invention showing relationship between bumper spaces on adjacent retention clips.

FIG. 10 is a close up view of a portion of the retention clip of FIG. 8.

FIG. 11 is a side view of an attached pivoting retention clip of the present invention.

### DETAILED DESCRIPTION

Through this description details are given of a DIMM and a DIMM connector, it should be understood that different circuit cards with different types of electronic components could be used with different connector sizes and configurations. It is intended that these specific details not limit the scope of the present invention but instead fully enable a one specific and best mode of the invention and other variations of this card and connector types are intended to be readily understood from the following description and included within the scope and spirit of the present invention.

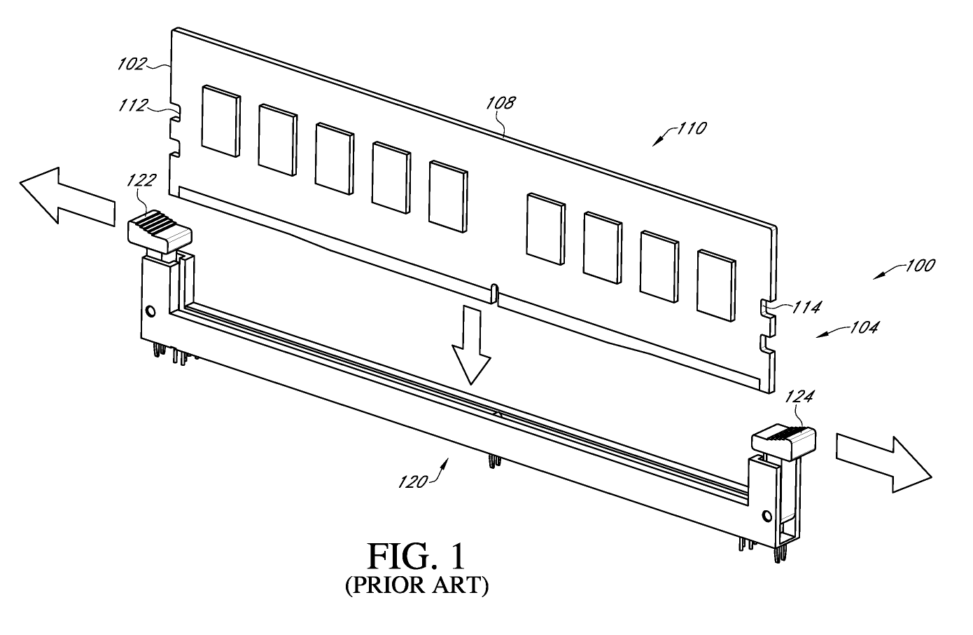

Now referring to the drawings wherein like numerals refer to like matter throughout, and more specifically referring to FIG. 1, there is shown a system of the prior art, generally designated 100, including a prior art DIMM and connector 100 including a DIMM memory module 110 and a DIMM connector 120. DIMM memory module 110 has a first end 102, a second end 104, a first end card notch 112 which provides a location for latching, a second end card notch 114 and a memory module top edge 108. In a manner which is well known in the art, the DIMM memory module 110 is inserted into DIMM connector 120, which cause first pivoting latch 122 and second pivoting latch 124 to rotate upwardly and latch at first end card notch 112 and second end card notch 114, respectively. In such prior art systems the DIMM memory module 110 can be removed by pushing outwardly (moving away from each other) on an upper portion of first pivoting latch 122 and second pivoting latch 124. If these upper portions are pushed away from each other simultaneously, the DIMM memory module 110 may be ejected from DIMM connector 120 into the air.

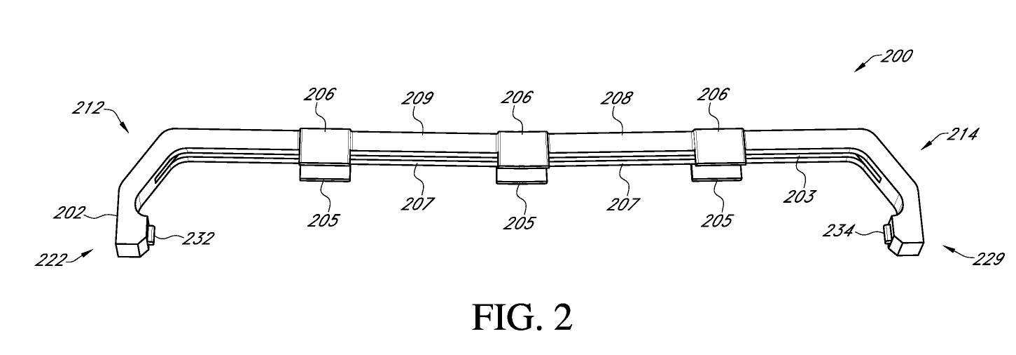

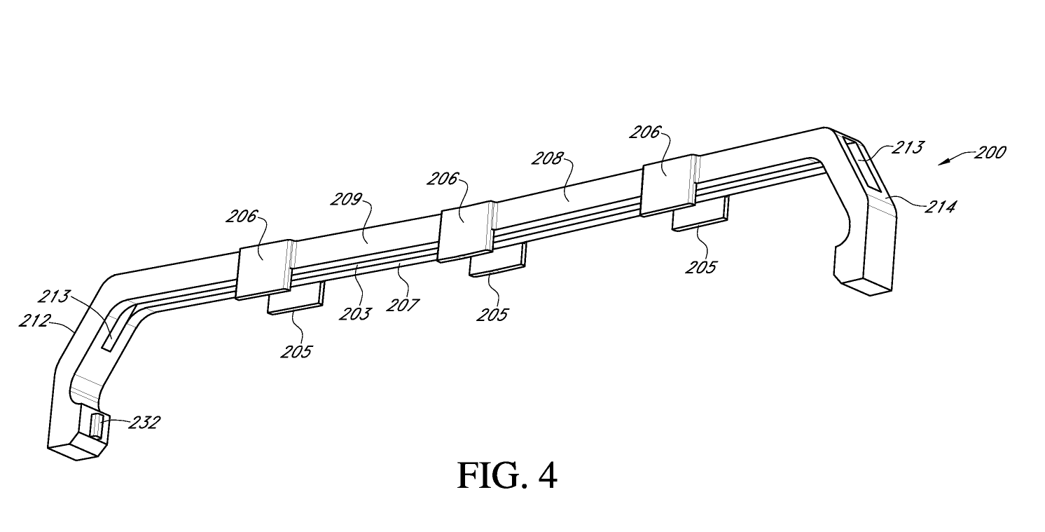

Now referring to FIG. 2, there is shown a retention clip 200 of the present invention, which comprises a retention clip first end 202, retention clip second end 204, a retention clip central portion 208, which has a retention clip central portion top side 209, a retention clip central portion bottom side 207 with a retention clip bottom side top edge receiving groove 203 therein. Retention clip central portion 208 has a retention clip first angled portion 212 and a retention clip second angled portion 214, which are adjacent to retention clip first latch engaging end 222 and retention clip second latch engaging end 224, respectively. Each of retention clip first angled portion 212 and retention clip second angled portion 214 has a memory module card corner receiving orifice 213 (FIG. 4) therethrough. Retention clip first latch engaging end 222 and retention clip second latch engaging end 224 have disposed thereon retention clip first latch engaging tab 232 and retention clip second latch engaging tab 234, respectively. Retention clip central portion 208 further has retention clip second face bumper spacer 205 and retention clip first face bumper spacer 206.

Retention clip 200 spans the longitudinal length of a standard JEDEC memory module such as DIMM memory module 110, such that each end, retention clip first end 202 and retention clip second end 204 of the retention clip 200, exerts through the retention clip first latch engaging end 222 and retention clip second latch engaging end 224, respectively; an inward pressure on the insertion and extraction of each latch; first pivoting latch 122 and second pivoting latch 124. The inward pressure is applied by retention clip 200 in such a way as to prevent rotation of first pivoting latch 122 and second pivoting latch 124 by exploiting the inherent tensile strength properties of the material from which it is constructed.

Key to the function of the retention clip 200 is the ability to flex around the first pivoting latch 122 and second pivoting latch 124 during the installation process of the DIMM memory module 110 into the DIMM connector 120, but provide adequate resistance to the inherent latch rotation during chassis deflection, which often occurs during operation of the compute platform. The retention clip 200 therefore must be resistant to elongation in some areas but allow for flexure in the areas necessary for rotating around the latches during installation. This is in essence a snap-fit approach to retaining the DIMM in the connector. Retention clip 200 has spring-like properties and can be made of any suitable material which provides for minimal stretching and compression in the longitudinal direction, but with the ability for limited flexing, bending or bowing in directions other than the longitudinal direction.

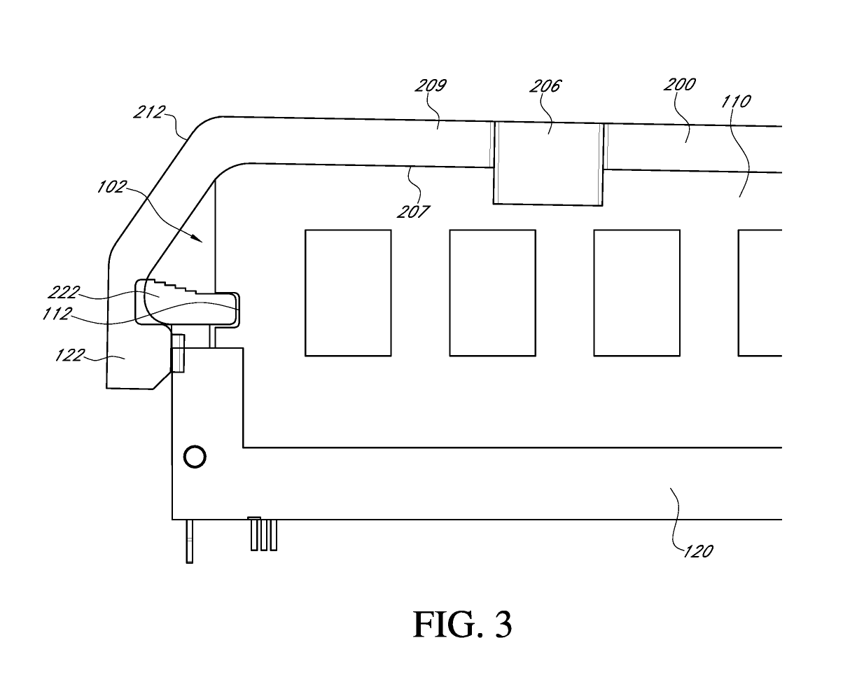

Now referring to FIG. 3, there is shown a portion of disconnection protected system which includes an installed DIMM memory module 110, in a DIMM connector 120 with a retention clip 200. More specifically there is shown; the first pivoting latch 122 disposed in a latched orientation with the retention clip first latch engaging end 222 portion of the retention clip 200 applying a biasing force on the first pivoting latch 122, which tends to keep the DIMM memory module 110 fully installed. Not visible in this Figure is retention clip first latch engaging tab 232, which is present but concealing inside a slot in first pivoting latch 122. A feature of the clip is the shape of the retention clip first latch engaging end 222 and retention clip second latch engaging end 224, which interface with first pivoting latch 122 and second pivoting latch 124. The angle of the retention clip 200 is designed to match that of the first pivoting latch 122 and second pivoting latch 124 such that a large force is required to allow rotation either latch.

Now referring to FIG. 4 there is shown an additional view of the retention clip 200. More visible in FIG. 4 is retention clip bottom side top edge receiving groove 203, which is configured to receive thereon a memory module top edge 108. Memory module card corner receiving orifices 213 are clearly shown in retention clip first angled portion 212 and retention clip second angled portion 214.

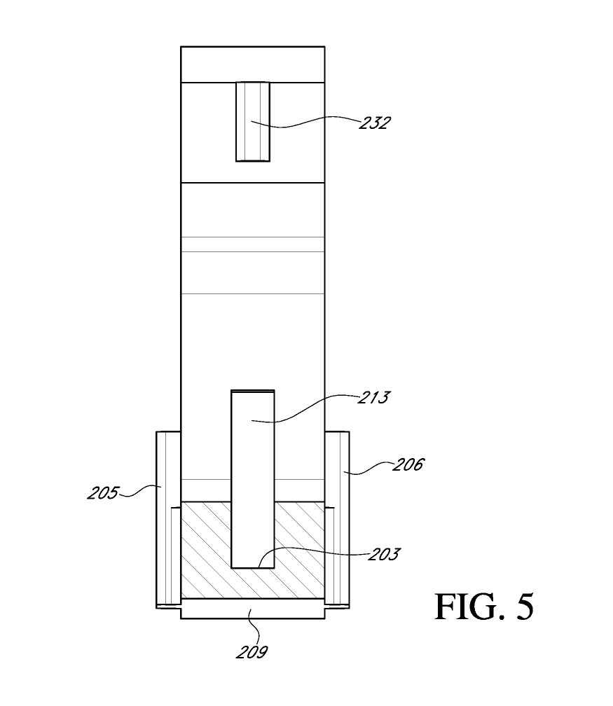

Now referring to FIG. 5, there is shown an upside down cross-sectional view of the retention clip 200 of FIG. 4 taken along retention clip central portion 208 at a point without a retention clip first face bumper spacer 206 of retention clip second face bumper spacer 205. The diagonally hatched portion represents the material of retention clip central portion 208 which would be “cut” to allow this view to exist. A preferred embodiment of the retention clip 200 uses a “C” channel construction along an edge of the retention clip 200 to restrain motion of the DIMM memory module 110 in a lateral direction when installed in DIMM connector 120.

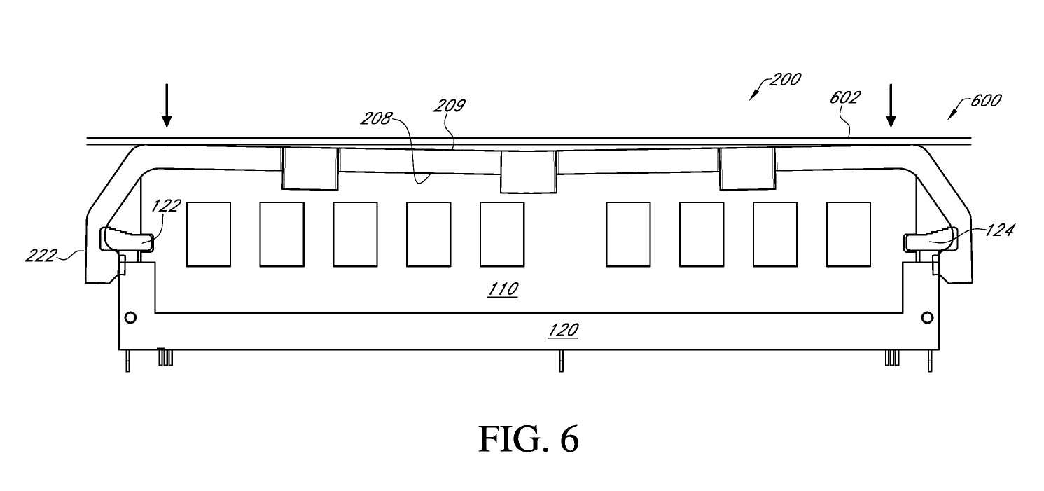

Now referring to FIG. 6, there is shown side view of a first one of, and only shown one of, a parallel array of disconnection protected systems of the present invention in their intended environment including retention clip 200. Edge of lid 602 is shown disposed over the first one but extends of all of the series of parallel systems each of which includes a retention clip 200, DIMM memory module 110 and DIMM connector 120 such that the lid 602 contacts and applies a pressure on retention clip central portion top side 209 for each of this series of retention clips 200. First pivoting latch 122 and second pivoting latch 124 are shown in a latched configuration with the retention clip 200 applying inward force therein which resists disconnection inducing rotation of the first pivoting latch 122 and second pivoting latch 124. In this preferred embodiment, the retention clip 200 would also contain a feature which created contact with some removable chassis structure to prevent motion of a rotational nature. In the description herein, this structure is the lid 602 or cover of the chassis. Having this structural interference with the retention clip 200 prevents rotation of first pivoting latch 122 and second pivoting latch 124 and insures connectivity of the memory circuits, however this interference is not required to make the innovation useful. A similar example of this feature is a simple curvature of the retention clip central portion 208 such that the lid applies force to the retention clip first latch engaging end 222 and retention clip second latch engaging end 224. Since the material has some spring characteristics, the contact with the lid 602 creates a force on the ends of first pivoting latch 122 and second pivoting latch 124, which further secures the DIMM memory module 110 into the DIMM connector 120.

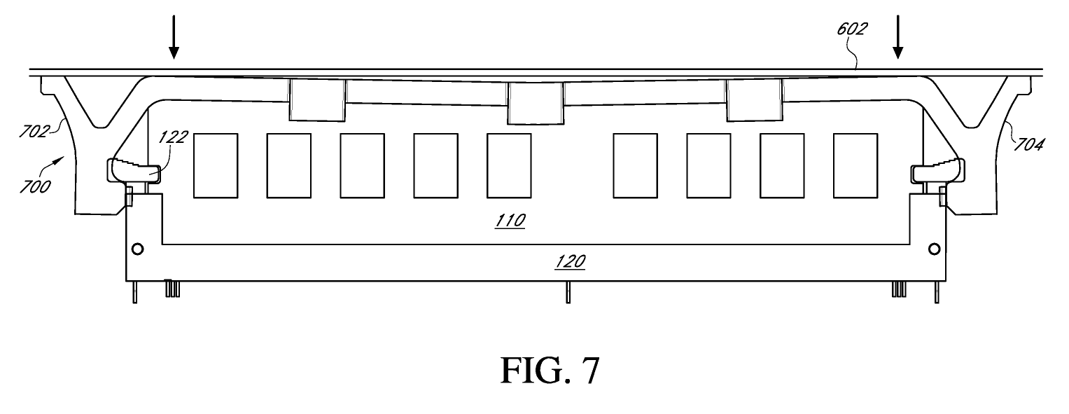

Now referring to FIG. 7, there is shown an alternate version of the present invention which includes buttressed retention clip 700, which is similar in many respects to retention clip 200 and which also includes first end lid contacting buttress 702 and second end lid contacting buttress 704 which can transmit force from the lid 602 to the first pivoting latch 122 and second pivoting latch 124 to provide additional biasing forces to prevent inadvertent rotation of the first pivoting latch 122 and second pivoting latch 124. Additionally, a feature of the buttressed retention clip 700 is to capture the memory module top edge 108 near the jes602 to resist lateral motion of the DIMM memory module 110 either through the resistance of the buttressed retention clip 700 to deflect laterally or by pressure applied by the lid 602.

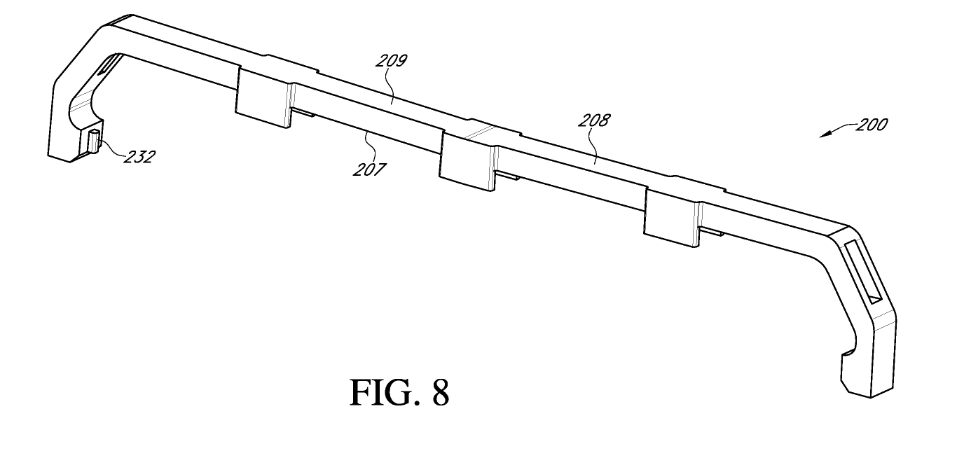

Now referring to FIG. 8, there is an alternate view of the retention clip 200, but from a more downwardly looking viewpoint.

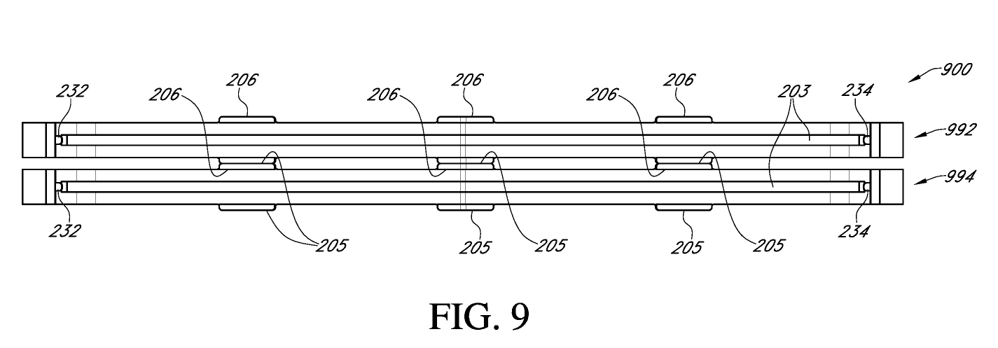

Now referring to FIG. 9, there is shown an upwardly looking view, of a parallel array of retention clips 200 which shows retention clip bottom side top edge receiving groove 203 and it also shows how a retention clip second face bumper spacer 205 of first parallel retention clip 992 contacts a retention clip first face bumper spacer 206 of second parallel retention clip 994, which helps to prevent lateral motion of the DIMM memory module 110. An additional feature of the retention clip 200 or buttressed retention clip 700 is to provide a self-aligning feature that allows for proper lateral spacing of the clips. This feature would be in the form of tapered retention clip second face bumper spacers 205 and retention clip first face bumper spacer 206 in the most obvious example, which guided one clip which was adjacent to another clip, such that alignment of second clip was optimum for installation on the second DIMM memory module.

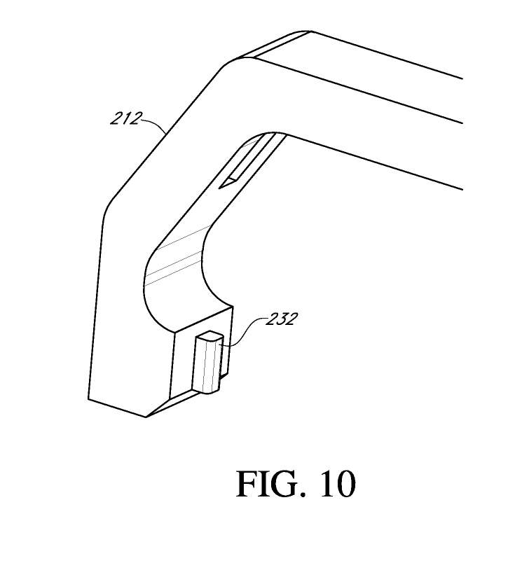

Now referring to FIG. 10, there is shown a close up view of the retention clip first end 202, which includes retention clip first latch engaging tab 232 which is on an interior side of retention clip first latch engaging end 222 and is designed to fit into a slot in first pivoting latch 122 during installation. The slot is present as a feature for the operation of the extraction and insertion action. The purpose of the retention clip first latch engaging tab 232 and retention clip second latch engaging tab 234 is to further deter rotation of the latch mechanism of the DIMM connector 120 by preventing upward motion on the retention clip 200, thereby separating it from the DIMM memory module 110 and DIMM connector 120 pair.

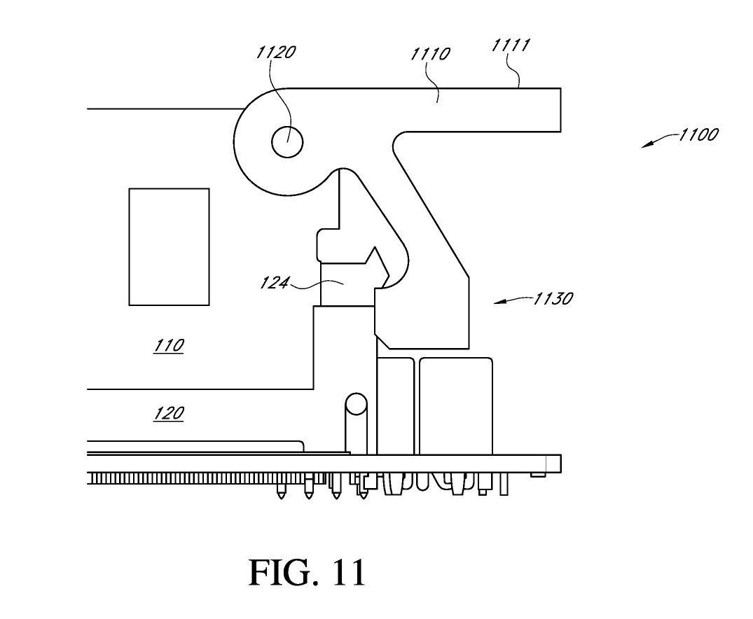

Now referring to FIG. 11, there is shown an alternative feature of the present invention, which includes: member for transmitting latch effecting forces 1110 with a top surface 1111. Member for transmitting latch effecting forces 1110 is connected to DIMM memory module 110 via module mounting structure 1120, which can be a rivet, peg or other structure which may or may not permit rotation of the member for transmitting latch effecting forces 1110 thereabouts. Latch engaging structure 1130 is similar in design and function to retention clip second latch engaging end 224. An additional advantage of this feature of the invention is to attach the retention clips directly to the memory modules using the JEDEC specified standard hole pattern on the module to fix the clip directly to the module using a pin or a rivet type of fastener, thereby eliminating loose pieces in the system.

Throughout this description, reference is made to an industrial PC and to a printed circuit board, because it is believed that the beneficial aspects of the present invention would be most readily apparent when used in connection with industrial PCs and printed circuit boards; however, it should be understood that the present invention is not intended to be limited to industrial PCs and printed circuit boards and should be hereby construed to include other non-industrial PCs and non-printed circuit boards as well.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

We claim:

1. A system for reducing inadvertent disconnection of memory modules during operation in harsh environments comprising:
a plurality of disconnection protected systems arranged in a parallel array; wherein each of said plurality of disconnection protected systems comprises:
a DIMM connector 120;
a DIMM memory module 110, having a memory module top edge 108;
a retention clip 200 having:
a retention clip central portion 208, having a retention clip first end 202 and retention clip second end 204;
a retention clip first angled portion 212 and retention clip second angled portion 214 disposed on opposing ends of said retention clip central portion 208;
a retention clip first latch engaging end 222 and a retention clip second latch engaging end 224 disposed on said retention clip first angled portion 212 and retention clip second angled portion 214, respectively;
said retention clip central portion 208 having a retention clip central portion top side 209 and a retention clip central portion bottom side 207, which has a retention clip bottom side top edge receiving groove 203 disposed therein, which is configured to receive therein said memory module top edge 108;
a plurality of retention clip first face bumper spacers 206;
a plurality of retention clip second face bumper spacers 205;
a retention clip first latch engaging tab 232 disposed on an interior side of said retention clip first latch engaging end 222;
a retention clip second latch engaging tab 234 disposed on an interior side said retention clip second latch engaging end 224 facing said retention clip first latch engaging tab 232; and
wherein said array is spatially configured such that each retention clip 200 in said plurality of disconnection protected systems has at least one of said plurality of retention clip first face bumper spacers 206 and said plurality of retention clip second face bumper spacers 205 thereon in contact with one of said plurality of retention clip first face bumper spacers 206 and said plurality of retention clip second face bumper spacers 205 of another retention clip 200 of said plurality of disconnection protection systems.

2. A system for reducing inadvertent disconnection of memory modules during operation in harsh environments comprising:
a DIMM connector 120, having a first pivoting latch 122 and a second pivoting latch 124;
a DIMM memory module 110, having a memory module top edge 108;
a retention clip system having:
a retention clip first latch engaging end 222 and a retention clip second latch engaging end 224 engaged with opposing ends of said DIMM memory module 110 and disposed beneath and in contact with an upper portion of said first pivoting latch 122 and said second pivoting latch 124, respectively; and
wherein said retention clip first latch engaging end 222 and said retention clip second latch engaging end 224 each provide a biasing force which tends to prevent rotation of first pivoting latch 122 and second pivoting latch 124, respectively.

3. The system of claim 2 further comprising:
a retention clip first latch engaging tab 232 disposed on said retention clip first latch engaging end 222;
a retention clip second latch engaging tab 234 disposed on said retention clip second latch engaging end 224; and
wherein said retention clip first latch engaging tab 232 and retention clip second latch engaging tab 234 are configured to fit inside a slot in first pivoting latch 122 and second pivoting latch 124, respectively.

4. The system of claim 2 wherein said retention clip first latch engaging end 222 and retention clip second latch engaging end 224 are pivotably mounted to opposing ends of said DIMM memory module 110.

5. The system of claim 2 wherein said retention clip first latch engaging end 222 and retention clip second latch engaging end 224 are disposed on opposing ends of a retention clip central portion 208 which is disposed on said memory module top edge 108.

6. The system of claim 3 wherein said retention clip first latch engaging end 222 and retention clip second latch engaging end 224 are pivotably mounted to opposing ends of said DIMM memory module 110.

7. The system of claim 3 wherein said retention clip first latch engaging end 222 and retention clip second latch engaging end 224 are disposed on opposing ends of a retention clip central portion 208 which is disposed on said memory module top edge 108.

8. The system of claim 5 further comprising:
a plurality of retention clip first face bumper spacers 206 disposed on said retention clip central portion 208; and
a plurality of retention clip second face bumper spacers 205 disposed on said retention clip central portion 208.

9. The system of claim 5 wherein said retention clip central portion 208 further comprises:
a. a retention clip central portion bottom side 207; and
b. a retention clip bottom side top edge receiving groove 203 disposed in said retention clip central portion bottom side 207, which is configured to receive therein said memory module top edge 108.

10. The system of claim 5 wherein said retention clip central portion 208 further comprises: a retention clip central portion top side 209 positioned and configured to be contacted by a lid 602.

11. The system of claim 10 further comprising a first end lid contacting buttress 702 and a second end lid contacting buttress 704.

12. A method of reducing inadvertent disconnection of memory modules during operation in harsh environments comprising the steps of:
providing a retention clip configured with a retention clip first latch engaging end 222 and a retention clip second latch engaging end 224:
installing a DIMM memory module 110 into a DIMM connector 120 having a first pivoting latch 122 and a second pivoting latch 124; and
engaging said retention clip with all of said DIMM memory module 110; and engaging said retention clip first latch engaging end 222 and said retention clip second latch engaging end 224 with said first pivoting latch 122 and said second pivoting latch 124, respectively.
